(19) United States
(12) Patent Application Publication
(10) Pub. No.: US 2010/0049761 A1
(43) Pub. Date: Feb. 25, 2010

(54) SEARCH ENGINE METHOD AND SYSTEM UTILIZING MULTIPLE CONTEXTS

(76) Inventor: Bijal Mehta, Bangalore (IN)

Correspondence Address: WINSTEAD PC, P.O. BOX 50784, DALLAS, TX, 75201, US

(21) Appl. No.: 12/544,022

(22) Filed: Aug. 19, 2009

Related U.S. Application Data
(60) Provisional application No. 61/090,737, filed on Aug. 21, 2008.

(51) Int. Cl. G06F 17/30

(52) U.S. Cl. 707/709; 707/770; 707/E17.108; 707/E17.032

(57) ABSTRACT

A method for context-based searching includes retrieving content over a computer network, segmenting the content into a plurality of cohesive segments, and identifying at least one cohesive segment of the plurality of cohesive segments with at least one context of a plurality of contexts. In the method, the plurality of contexts are resident on one more computer-readable storage media in a searching system. The method further includes indexing, in the plurality of contexts, the plurality of cohesive segments identified with the plurality of contexts.

### CROSS-REFERENCE TO RELATED APPLICATIONS

This patent application claims priority from, and incorporates by reference the entire disclosure of, U.S. Provisional Patent Application No. 61/090,737, filed on Aug. 21, 2008.

### BACKGROUND

1. Technical Field

This application relates generally to the field of search engines and, in particular, to search engine systems and methods for context-based searching.

2. History Of Related Art

Search engines facilitate retrieval of relevant Internet content based on keywords entered by an Internet user. Search engines such as, for example, the Google™ search engine retrieve Internet content from an Internet-wide content base. The Internet-wide content base is, at least in part, a product of web crawler applications that scour the Internet and regularly supply additional content to already massive searchable listings. The Internet-wide content base characteristic of search engines significantly complicates selection of listings for presentation to the Internet user, particularly when the Internet user wishes to obtain a particular type of information. This is because, when the Internet user searches, all listings in the Internet-wide content base are subject to search and retrieval.

In contrast to a search engine, some websites serving, for example, a niche purpose instead provide search features that permit an Internet user to search proprietary content bases available to the websites. For example, many websites offer searchable phone listings, patents, or résumé listings based on phone listings, patents, or résumé listings that are accessed from the websites' storage media. Search features allow the Internet user to search the proprietary content bases and benefit from the fact that, presumably, all included content is relevant to the niche purposes served by the respective websites. Such search features, however, restrict the Internet user to individually searching proprietary content bases.

### SUMMARY OF THE INVENTION

In one embodiment, a context-based searching method includes retrieving content over a computer network and segmenting the content into a plurality of cohesive segments. The method further includes identifying at least one cohesive segment of the plurality of cohesive segments with at least one context of a plurality of contexts resident on one more computer-readable storage media in a searching system and indexing, in the plurality of contexts, the at least one cohesive segment identified with the at least one context.

In another embodiment, a context-based searching system includes a searching system and a content procurement and organization system. The searching system includes at least one searching machine and a plurality of contexts resident on one or more computer-readable storage media on or accessible to the at least one searching machine. The content procurement and organization system includes a web crawling system, a context identifier, and a context indexer. The web crawling system includes a web crawler that retrieves content over a computer network. The context identifier is operable to segment the content into a plurality of cohesive segments and identify at least one cohesive segment of the plurality of cohesive segments with at least one context of the plurality of contexts. The context indexer is operable to index, in the plurality contexts, the at least one cohesive segment identified with the at least one context.

In yet another embodiment, an article of manufacture for context-based searching includes at least one computer readable medium and processor instructions contained on the at least one computer readable medium. The processor instructions are configured to be readable from the at least one computer readable medium and thereby cause the processor to operate as to retrieve content over a computer network, segment the content into a plurality of cohesive segments, identify at least one cohesive segment of the plurality of cohesive segments with at least one context of a plurality of contexts resident on one more computer-readable storage media in a searching system, and, in the plurality of contexts, index the at least one cohesive segment identified with the at least one context.

In another embodiment, a context-based searching method includes receiving a search request and a selection of at least one context of a plurality of contexts from a user, the plurality of contexts being resident on at least one computer-readable medium in a searching system, the plurality of contexts each containing a plurality of cohesive segments of content identified with the context. The context-based searching method further includes searching only the at least one user-selected context of the plurality of contexts and, responsive to the searching step, retrieving cohesive segments from the at least one user-selected context. The context-based searching method also includes, over the computer network, providing the retrieved cohesive segments by context to the user.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a search interface for context-based searching;

FIG. 2 illustrates search results from a context-based search;

FIG. 3 is a block diagram illustrating a search engine system;

FIG. 4 is a block diagram illustrating an Internet content procurement and organization system;

FIG. 5 illustrates a flow diagram of a process for filtering a list of Uniform Resource Locators (URLs) for spam URLs;

FIG. 6 illustrates an exemplary segmentation of Internet content;

FIG. 7 is a diagram of a context identifier and indexer;

FIG. 8 is a flow diagram illustrating a process for identifying cohesive segments with a context;

FIG. 9 is a table of exemplary tokens that may be suggestive of various contexts;

FIG. 10 is a diagram of a context-identifier algorithm for identifying cohesive segments with a finance context;

FIG. 11 is a flow diagram illustrating a process for utilizing a system for context-based searching; and

FIG. 12 is a flow diagram illustrating a process for performing a context-based search.

### DETAILED DESCRIPTION

Various embodiments of the present invention will now be described more fully with reference to the accompanying drawings. The invention may, however, be embodied in many different forms and should not be constructed as limited to the embodiments set forth herein; rather, the embodiments are provided so that this disclosure will be thorough and complete, and will fully convey the scope of the invention to those skilled in the art.

Various embodiments of the invention utilize a system and method for context-based searching of cohesive segments of Internet content that offer numerous advantages over search engines and search features known in the art. A context is considered to be a physical or logical computer-readable storage container for storing a specific type of information. A context termed “sports,” for example, could be a computer-readable storage medium for storing sports-related content or, by way of further example, a database for storing sports-related content. A cohesive segment is considered to be a segment of Internet content that has been determined to have independent contextual significance.

Some embodiments of the invention contemplate dividing newly discovered Internet content into cohesive segments and identifying one or more contexts applicable to the cohesive segments. These embodiments further contemplate indexing the cohesive segments according to the one or more identified contexts and enabling retrieval of cohesive segments by an Internet user through a context-based search interface. In that way, search efficiency is improved and the Internet user is empowered to direct searches to contexts most likely to include desired content.

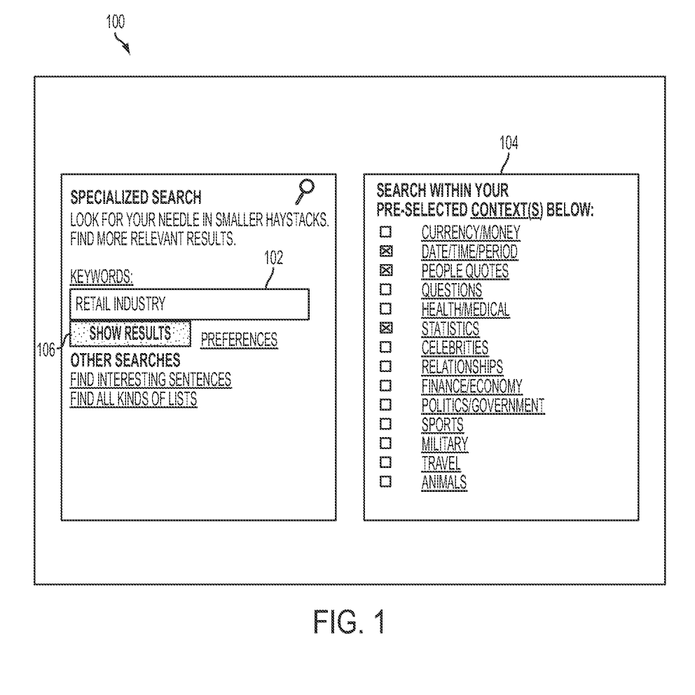

FIG. 1 illustrates a search interface 100 for performing a context-based search of cohesive segments of Internet content. The search interface 100 accepts a search request 102 entered by an Internet user. One of ordinary skill in the art will recognize that the search request may include, for example, various combinations of keywords, Boolean operators, or other search attributes. The search interface 100 further accepts from the Internet user a selection of one or more of a plurality of contexts 104 to be searched using the search request 102. Selection of ones of the plurality of contexts 104 allows the Internet user to select one or more computer-readable storage containers for searching using the search request 102.

Still referring to FIG. 1, each of the plurality of contexts 104 may, for example, be defined by currency/money, date/time/period, people quotes, questions, health/medical, statistics, celebrities, relationships, finance/economy, politics/government, sports, military, travel, animals, or any other specific type of information. Each of the plurality of contexts 104 generally only encapsulates a specific type of information defining the context. For example, a context of “travel” within the plurality of contexts 104 typically only includes Internet content that has been specifically identified with the travel context and a context of “animals” within the plurality of contexts 104 typically only includes Internet content that has been specifically identified with the animals context. In a typical embodiment, since only travel Internet content is encapsulated by the travel context, any search results produced from searching the travel context will by definition in some way relate to travel.

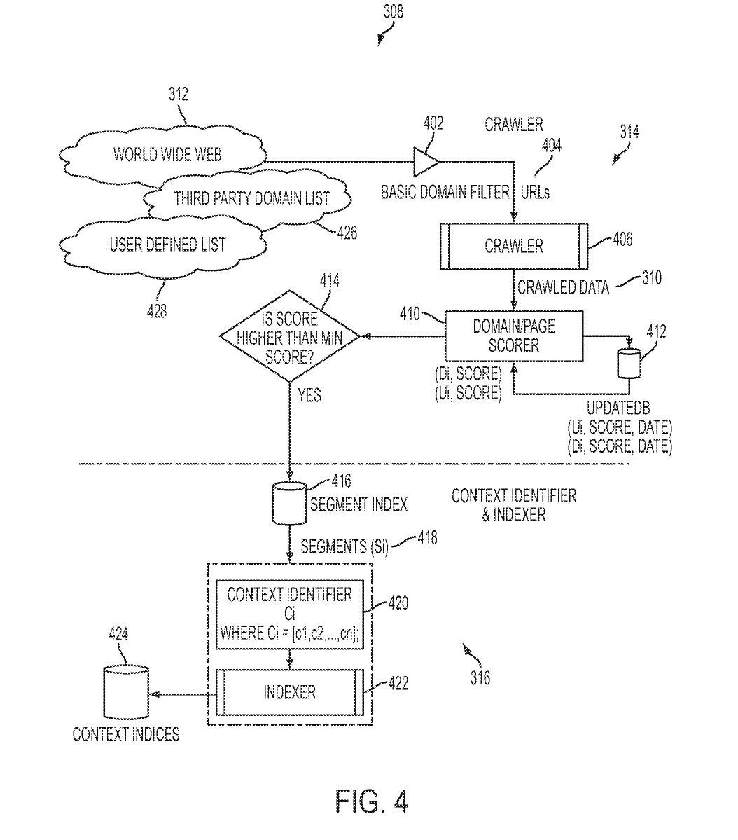

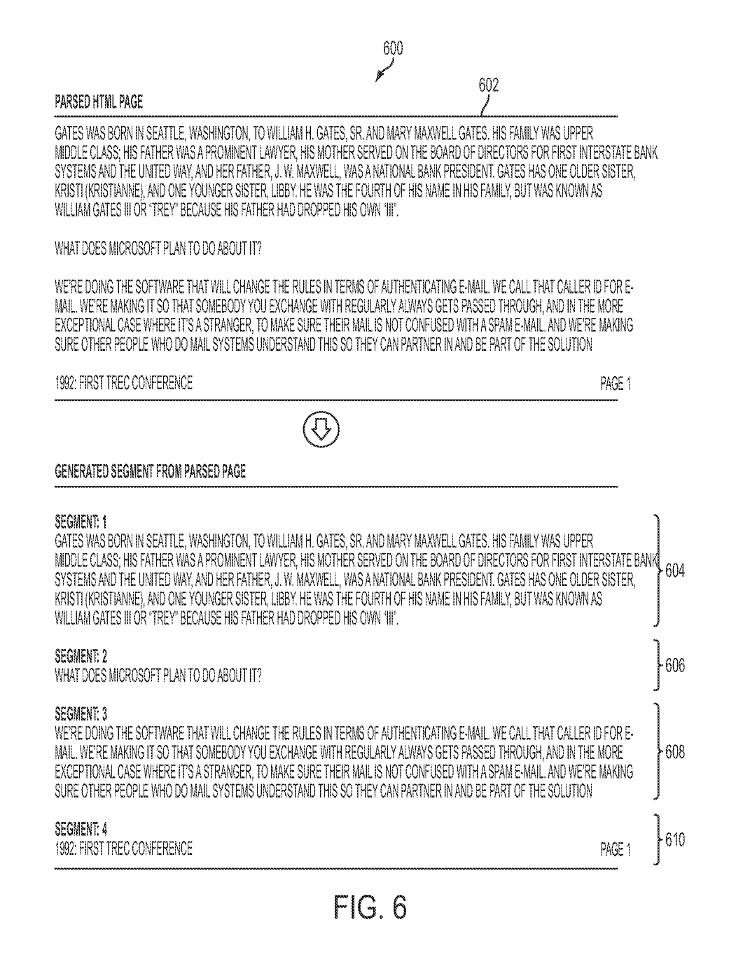

In a typical embodiment, rather than storing all Internet content from entire web pages, each of the plurality of contexts 104 stores cohesive segments of Internet content that have been individually identified with the specific types of information stored by the context. A single web page will generally yield multiple cohesive segments of Internet content, although this will not always be the case. Segmentation of Internet content into cohesive segments will be described in more detail with respect to FIGS. 4 and 6. After the cohesive segments are generated, the cohesive segments are identified with one or more of the plurality of contexts 104. Not all cohesive segments are necessarily identified with the same ones of the plurality of contexts 104.

For example, although a web page may generally discuss football, oftentimes not all content of the web page will relate to football and some content may in fact relate to multiple ones of the plurality of contexts 104. In a typical embodiment, a first cohesive segment may discuss playoff teams, a second cohesive segment may discuss players that have been arrested, and a third cohesive segment may discuss a former player that is running for government office. Depending on a context-identifier algorithm that is employed, the cohesive segments discussing playoff teams may be identified with a sports context, the cohesive segments discussing players that have been arrested may be identified with both a sports context and a celebrity context, and the cohesive segments discussing the former player running for government office may be identified with a politics/government context. In some embodiments, through segmentation and identification of cohesive segments with ones of the plurality of contexts 104, each of the plurality of contexts 104 achieves a content base that is Internet-wide in nature yet reliably and tightly related with the specific type of information stored by the context. Context identification will be described in more detail with respect to FIGS. 4 and 7-10.

FIG. 1 further illustrates a typical embodiment in which the Internet user has entered “retail industry” as the search request 102 and has selected various ones of the plurality of contexts 104. Particularly, the Internet user has selected date/time/period, people quotes, and statistics from among the plurality of contexts 104. Therefore, the Internet user has selected three corresponding computer-readable storage containers for context-based searching using the search request 102.

When the Internet user activates a “Show Results” button 106, contexts within the plurality of contexts 104 of date/time/period, people quotes, and statistics are searched using the search request 102 of “retail industry.” Ones of the plurality of contexts 104 that have not been selected are not searched. As a result, only date/time/period, people quotes, and statistics are searched and only date/time/period information, people quotes, and statistics are returned. Irrelevant search results such as, for example, those only identified with the celebrities context or the travel context are not returned. In some embodiments, by limiting searching to relevant ones of the plurality of contexts 104 in this manner, search effectiveness and search efficiency are improved.

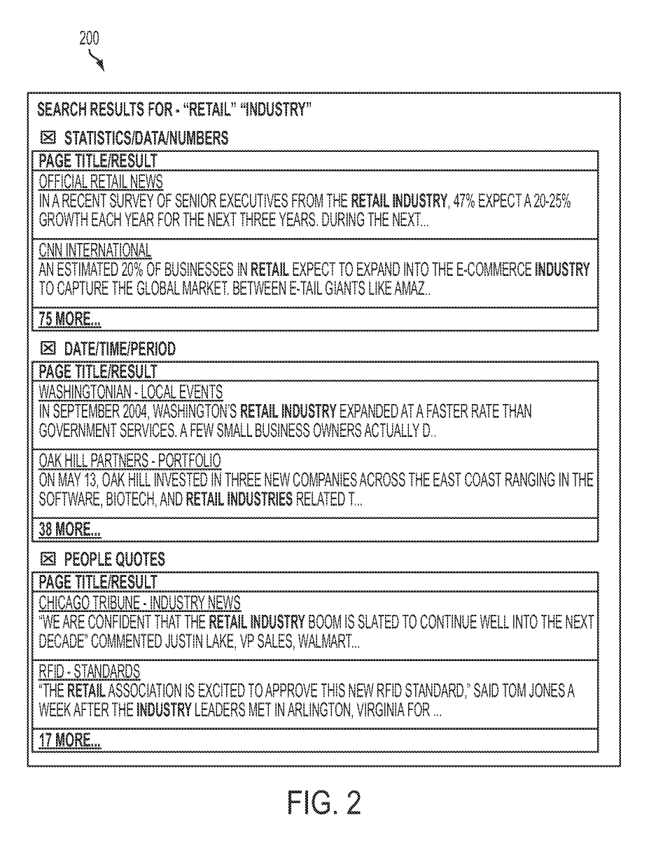

FIG. 2 illustrates exemplary search results 200 resulting from usage of the search interface 100. The exemplary search results 200 include cohesive segments of Internet content sorted by the selected ones of the plurality of contexts 104 selected by the Internet user for the context-based search. Since, in FIG. 1, the Internet user selected statistics, date/time/period, and people quotes from among the plurality of contexts 104, the exemplary search results 200 include cohesive segments of Internet content from each of the selected contexts.

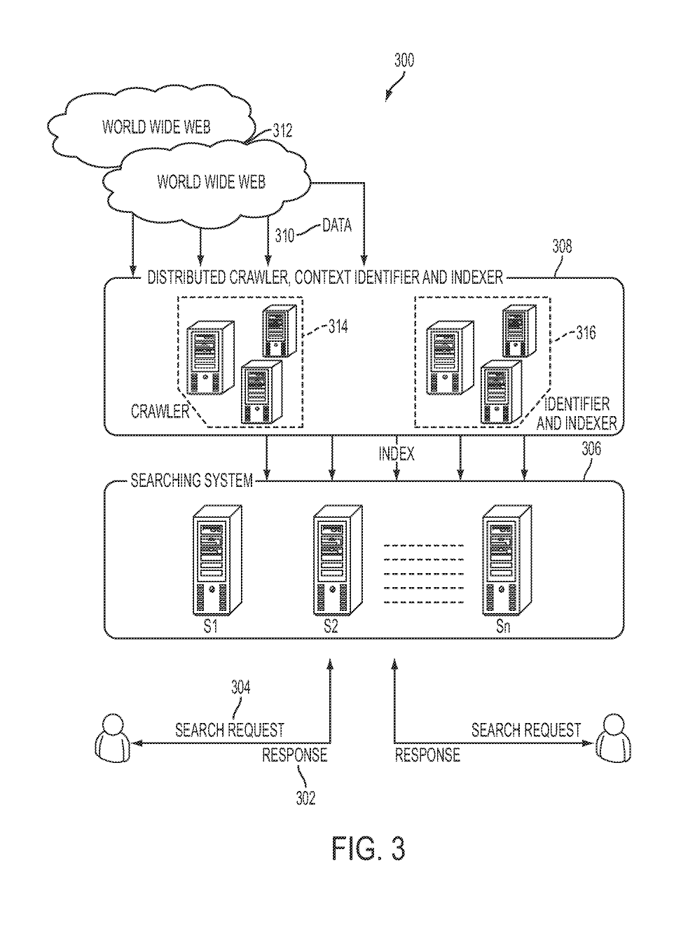

FIG. 3 is a diagram of a search engine system 300 for context-based searching. An Internet content procurement and organization system 308 accesses Internet content 310 from an Internet cloud 312 and indexes the Internet content 310 for searching in a searching system 306. The plurality of contexts 104 is contained within the searching system 306. Because the searching system 306 searches only ones of the plurality of contexts 104 that are selected rather than an entire content base of searchable listings, in various embodiments, the workload of the searching system 306 is greatly reduced. Further, in some embodiments, search efficiency may be further enhanced by providing each of a plurality of server machines with a separate copy of the plurality of contexts 104. In this manner, load balancing may be effectively applied by directing a search request to a server machine in the plurality server machines that is geographically closest to an origination point of the search request. In these embodiments, the separate copy of the plurality of contexts 104 resident on each of the plurality of server machines enables the plurality contexts 104 to be locally searched without the need for additional network traffic.

Still referring to FIG. 3, the Internet content procurement and organization system 308 includes a web crawling system 314 and a context identifier and indexer 316. The searching system 306 receives search requests 304 from Internet users, such as, for example, through the search interface 100 shown in FIG. 1, and provides search results 302 to the Internet users based on the search requests 304. In various embodiments, the web crawling system 314, the context identifier and indexer 316, and the searching system 306 may each embody a single network-accessible server machine in a particular geographic location or, instead, multiple server machines in a distributed network environment across multiple geographic locations.

Still referring to FIG. 3, the Internet content procurement and organization system 308 retrieves the Internet content 310 from the Internet cloud 312. In a typical embodiment, the Internet content procurement and organization system 308 is operable to segment the Internet content 310 into cohesive segments, which cohesive segments are then identified with ones of the plurality of contexts 104. The cohesive segments identified with one or more of the plurality of contexts 104 are then indexed in context indices within the context identifier and indexer 316. The searching system 306 is then synchronized with the context identifier and indexer 316 via, for example, an index synchronizer process in the context identifier and indexer 316. In that way, consistency is maintained between the plurality of contexts 104 resident in the searching system 306 and the Internet content procurement and organization system 308.

FIG. 4 is a block diagram illustrating the Internet content procurement and organization system 308 in more detail. The web crawling system 314 further includes a domain filter 402, a web crawler 406, and a domain scorer 410. The context identifier and indexer 316 further includes a context identifier 420 and a context indexer 422.

Still referring to FIG. 4, operation of the domain filter 402 will be described. In a typical embodiment, the domain filter 402 receives a Uniform Resource Locator (URL) list, for example, from the Internet cloud 312, a third-party domain list 426, or a custom-defined domain list 428. The domain filter 402 operates to ensure that known non-reputable sources of information are not indexed in the searching system 306. For that reason, the domain filter 402 filters the URL list, for example, for spam URLs. For example, spam URLs are URLs that are non-legitimate URLs or are otherwise not reputable sources of information. In some embodiments, spam URLs can be identified through usage of a pre-defined rule or a spam database. FIG. 4 will be discussed further below.

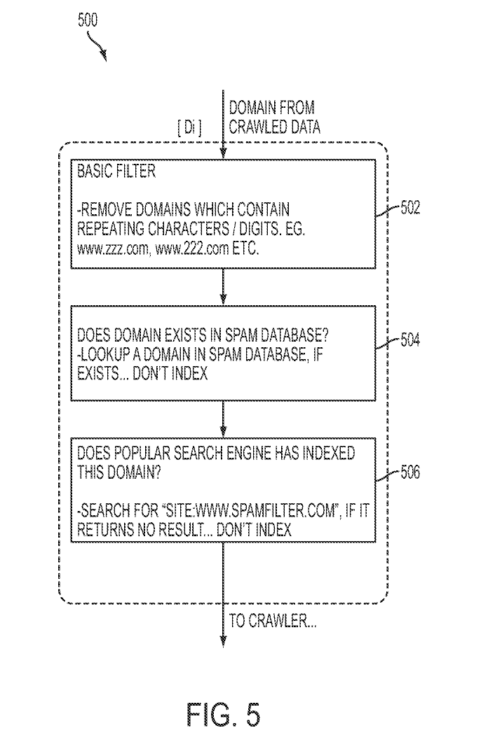

FIG. 5 illustrates a flow diagram of a process 500 for utilizing the domain filter 402. Often, certain URL characteristics, such as repeating characters or digits in a domain name (e.g., www.zzz.com), suggest that URLs are spam URLs. For instance, at step 502, URLs that contain repeating characters or digits are removed from the URL list. Other similar rules may be used and will be apparent to one of ordinary skill in the art. From step 502, the process 500 proceeds to step 504. At step 504, a spam database of known spam URLs is consulted. The spam database may be a database accessible within the search engine system 300 or a database provided externally from a third-party source. URLs identified as being in the spam database are removed from the URL list. From step 504, the process 500 proceeds to step 506.

At step 506, one or more established search engines are referenced to determine if the URLs remaining in the URL list are indexed by the one or more established search engines. For example, a rule could be specified that, if a URL is not indexed by the Google™ search engine or the Yahoo™ search engine, then the URL is to be removed from the URL list. Under this rule, the fact that a URL is not indexed by the Google™ search engine or the Yahoo™ search engine is highly suggestive that the URL is of questionable credibility. Hence, when this rule is followed, such URLs are considered spam URLs and are removed from the URL list. With reference to FIG. 4, an output of the domain filter 402 is a filtered URL list 404.

Referring again to FIG. 4, the filtered URL list 404 is provided to the web crawler 406. The web crawler 406 accesses the Internet content 310 for each URL in the filtered URL list 404 and provides the Internet content 310 indexed by URL to the domain scorer 410. The domain scorer 410 evaluates on a URL-by-URL basis whether the Internet content 310 meets a minimum quality standard for inclusion in the searching system 306. The domain scorer 410 generates a score for each URL represented in the Internet content 310. In a typical embodiment, each score is stored in a scores database 412 by URL and date. If a URL does not meet the minimum quality standard as defined by a predefined minimum score, denoted by decision block 414, the Internet content 310 corresponding to that URL is discarded. The Internet content 310 may be scored by any one of many scoring algorithms known in the art. For example, one such possible scoring algorithm is disclosed by U.S. Pat. No. 6,285,999, which patent is hereby incorporated by reference.

Still referring to FIG. 4, the Internet content 310 meeting the minimum quality standard is divided into cohesive segments 418 and stored in segment indices 416. As stated above, a cohesive segment is a segment of Internet content that has been determined to have independent contextual significance. In various embodiments, independent contextual significance may be established by analyzing, for example, sentence structure, paragraph structure, or common textual structures. In other embodiments, independent contextual significance may be established by utilizing applications of natural language processing. In still other embodiments, rules may be developed for systematically segmenting the Internet content 310, for example, by sentence or paragraph.

FIG. 6 is a diagram of an exemplary segmentation 600. Internet content 602 represents exemplary Internet content retrieved by the web crawler 406 for a given URL. The Internet content 602 is segmented into cohesive segments 604, 606, 608, and 610. In the case of exemplary segmentation 600, the cohesive segments 604, 606, 608, and 610 correspond to paragraphs of the Internet content 602.

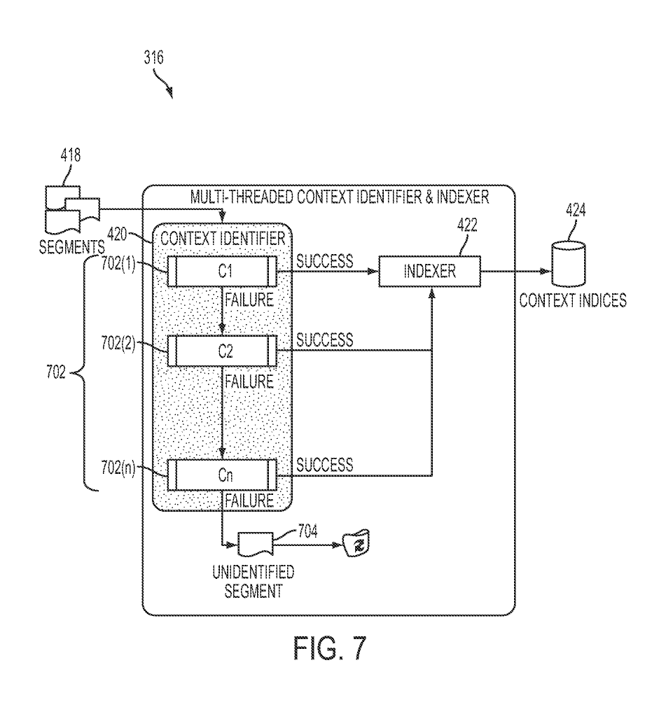

FIG. 7 is a diagram of the context identifier and indexer 316. Referring to FIG. 7 in conjunction with FIG. 4, operation of the context identifier and indexer 316 will now be described. The context identifier 420 manages a series of context-identifier modules 702(1)-(n) that each implements a context-identifier algorithm. Hereinafter, the series of context-identifier modules 702(1)-(n) are referred to collectively as context-identifier modules 702. Each context-identifier module in the context-identifier modules 702, and correspondingly each of the implemented context-identifier algorithms, is assigned to one of the plurality of contexts 104 that is searchable in the context-based search. In a typical embodiment, there is a one-to-one correspondence between the plurality of contexts 104 and the context-identifier modules 702. It is contemplated that context-identifier modules may be added or removed from the context-identifier modules 702 as ones of the plurality of contexts 104 are added or removed from the searching system 306. When the context identifier 420 accesses cohesive segments 418 from the segment indices 416, the context identifier 420 first ascertains whether the URLs from which the accessed cohesive segments were obtained are already represented in the context indices 424. For any such URLs, corresponding indices in the context indices 424 will be updated to reflect any new or different content. Otherwise, indices in the context indices 424 will be created.

Still referring to FIG. 7 in conjunction with FIG. 4, each context-identifier module in the context-identifier modules 702 is operable to individually analyze the cohesive segments 418 in order to determine whether each cohesive segment 418 belongs to the respective assigned context. Each context-identifier module in the context-identifier modules 702 produces a Boolean result indicating whether a segment being analyzed is deemed to belong to the respective assigned context. If the Boolean result is true, the context indexer 422 stores and indexes the segment being analyzed for the respective assigned context in the context indices 424. If the Boolean result is false, the segment being analyzed is passed to another context-identifier module in the context-identifier modules 702.

In the event that all context-identifier modules in the context-identifier modules 702 generate a false result, the segment being analyzed is considered an unidentified segment 704 and is discarded. It should be noted that it is possible, by proceeding through the context-identifier modules 702, for ones of the cohesive segments 418 to be identified with more than one context. By way of example, a cohesive segment 418 related to Michael Jordan could be identified with both a “celebrity” context and a “sports” context. Referring to FIGS. 3 and 4 together, after indices in the context indices have been created or updated as appropriate, an index synchronizer process within the context indexer 422 synchronizes the plurality of contexts 104 resident in the searching system 306 with the context indices 424. In this manner, those cohesive segments 418 that are identified with one or more of the plurality of contexts 104 are indexed in the searching system 306. In some embodiments, the searching system 306 may be synchronized at periodic predetermined intervals such as, for example, daily. In other embodiments, the searching system 306 may be synchronized whenever indices in context indices 424 are created or updated.

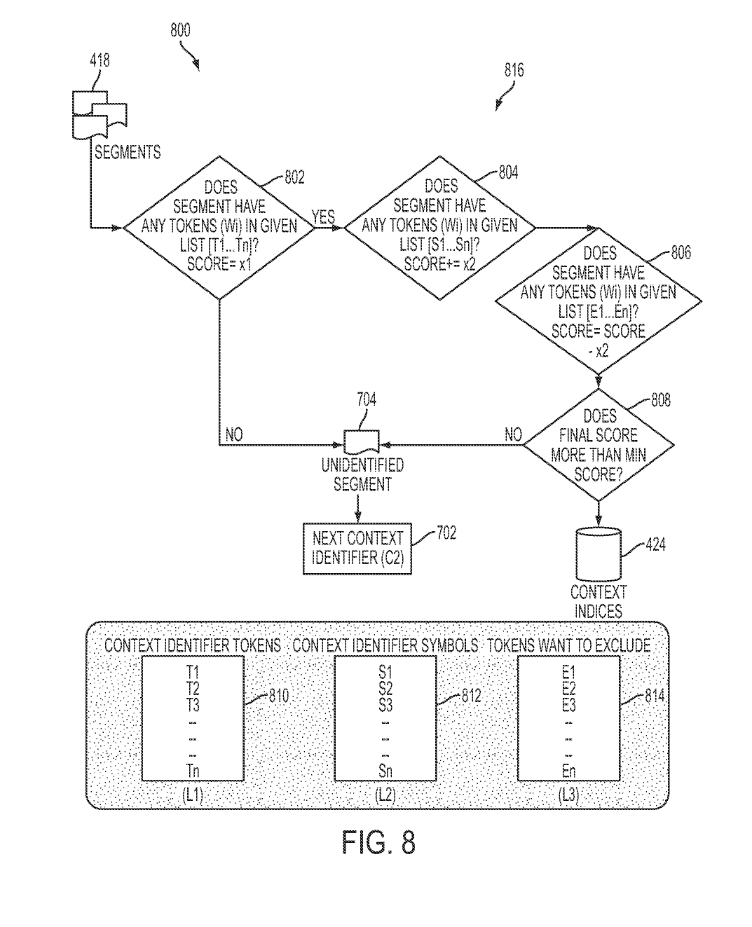

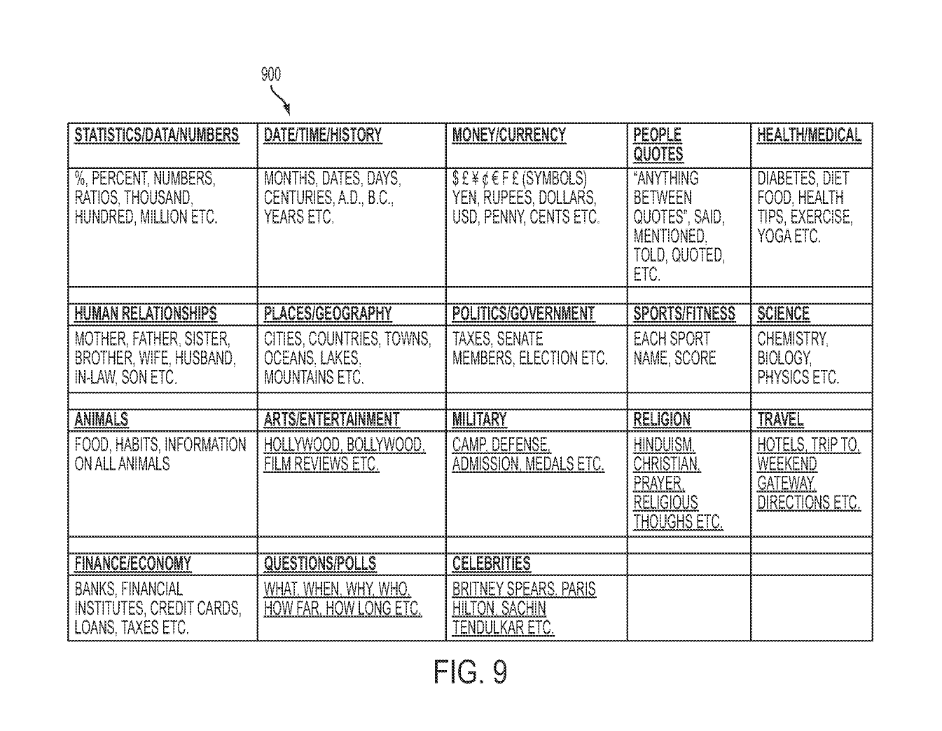

FIG. 8 is a flow diagram of a process 800. The process 800 embodies a context-identifier algorithm 816 that, in some embodiments, may be implemented by a context-identifier module in the context-identifier modules 702. The context-identifier algorithm 816 employs a token inclusion list 810, a symbol inclusion list 812, and a token exclusion list 814. The token inclusion list 810 includes words or phrases that, if present in the segment being analyzed, are suggestive of the assigned context. Similarly, the symbol inclusion list 812 includes symbols that, if present in the segment being analyzed, are suggestive of the assigned context. Conversely, the token exclusion list 814 includes words that, if present in the segment being analyzed, weigh against the assigned context. Table 900 of FIG. 9 lists exemplary tokens and symbols that may be suggestive of various ones of the plurality of contexts 104.

Still referring to FIG. 8, the context-identifier algorithm 816 operates by calculating a context score for the segment being analyzed. The higher the context score, the more probable it is that the segment being analyzed properly belongs in the assigned context. With reference again to the process 800, at step 802, it is determined how many tokens from the token inclusion list 810 are contained within the segment being analyzed. If no tokens from the token inclusion list 810 are found, the segment being analyzed is treated as an unidentified segment 704 and the process 800 ends. If at step 802 tokens from the token inclusion list 810 are found, points are added to the context score according to a predetermined formula based on, for example, number and frequency of tokens from the token inclusion list 810 in the segment being analyzed. In this latter scenario, the process 800 continues proceeds from step 802 to step 804. Those having skill in the art will appreciate that steps 802-806 can be performed in a different order from that set forth above.

At step 804, it is determined how many symbols from the symbol inclusion list 812 are contained within the segment being analyzed. Based on, for example, a number and frequency of symbols from the symbol inclusion list 812 found within the segment being analyzed, the context score is increased according to the predetermined formula. From step 804, the process 800 proceeds to step 806. At step 806, it is determined how many tokens from the token exclusion list 814 are contained within the segment being analyzed. Based on, for example, a number and frequency of tokens from the token exclusion list 814 in the segment being analyzed, the context score is reduced according to the predetermined formula. From step 806, the process 800 proceeds to step 808. At step 808, if the context score is greater than a predetermined minimum context score, the context indexer 422 stores and indexes the segment being analyzed in context indices 424 for the context assigned to a context-identifier module in the context-identifier modules 702 implementing the context-identifier algorithm 816. Otherwise, the segment being analyzed is discarded.

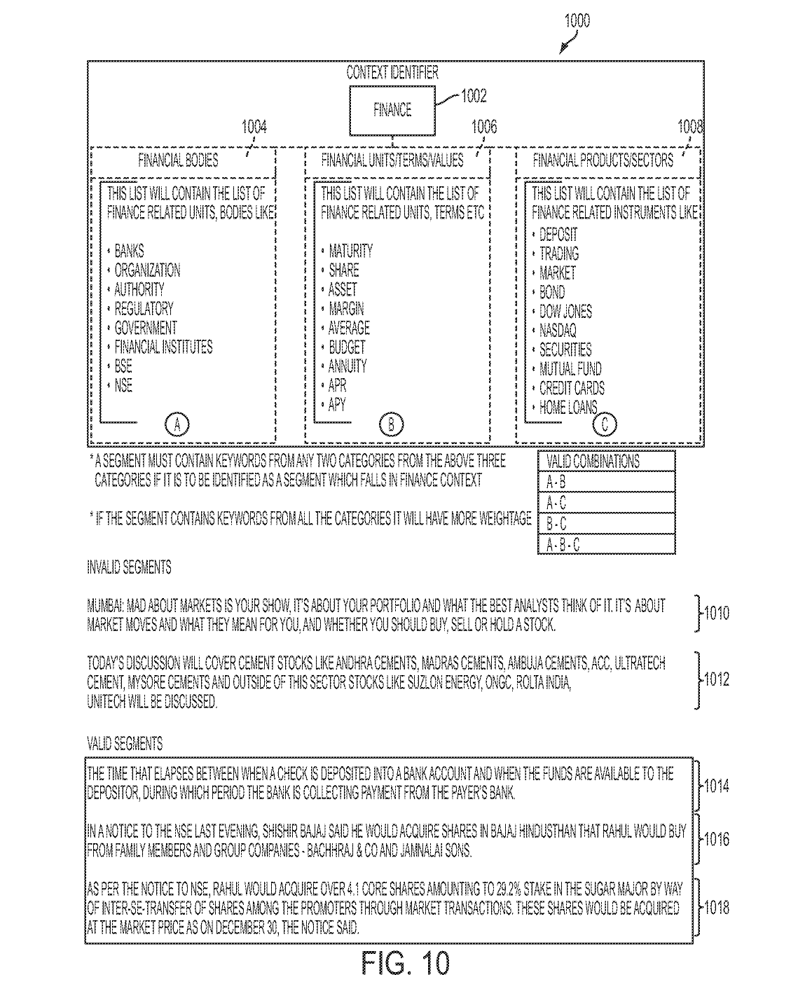

FIG. 10 illustrates a context-identifier algorithm 1000 that may be implemented by one of the context-identifier modules in the context-identifier modules 702. The context-identifier algorithm 1000 is an algorithm for a finance context 1002. The context-identifier algorithm 1000 employs finance token lists 1004, 1006, and 1008. In a typical embodiment, the finance token list 1004 includes a list of finance-related bodies such as, for example, banks, financial institutes, regulatory authorities, and the like. In a typical embodiment, the finance token list 1006 includes a list of finance-related units and terms such as for example, share, maturity, and the like. In a typical embodiment, the finance token list 1008 includes a list of finance-related products, sectors, and instruments such as, for example, market, bond, credit card, and the like.

Still referring to FIG. 10, the context-identifier algorithm 1000 requires that the segment being analyzed contain tokens from at least two of the finance token lists in order to belong to the finance context 1002. By way of example, segments 1010 and 1012 do not contain tokens from two of the finance token lists and therefore will not be indexed for the finance context 1002. In contrast, segments 1014, 1016 and 1018 each contain tokens from two of the finance token lists and therefore will be indexed for the finance context 1002 in context indices 424. In some embodiments, weights may be assigned to cohesive segments 418. For example, if the segment being analyzed contains tokens from more than the required number of token lists, the assigned weight would be higher in order to indicate a higher degree of identification with the finance context 1002.

In various embodiments, the plurality of contexts 104 may be organized into a hierarchy so that some of the plurality of contexts 104 may have relationships with others of the plurality of contexts 104. For instance, one of the plurality of contexts 104 may be a subset of another of the plurality of contexts 104. Moreover, although in some embodiments there is a one-to-one correspondence between the plurality of contexts 104 and context identifiers 420, in other embodiments, there are benefits from forming a many-to-many relationship between the plurality of contexts 104 and context identifiers 420. In other words, multiple ones of the context-identifier modules 702 may be assigned to one of the plurality of contexts 104 and a single context-identifier module in the context-identifier modules 702 may be assigned to multiple ones of the plurality of contexts 104.

In some embodiments, it may be advantageous to assign multiple ones of the context-identifier modules 702 to a single one of the plurality of contexts 104. For example, there may be multiple alternative context-identifier algorithms for a particular one of the plurality of contexts 104 so that if any one of the multiple context-identifier algorithms produces a true result, the segment being analyzed may be identified with the particular context. For purposes of simplicity, rather than combining the multiple alternative algorithms into one context-identifier module in the context-identifier modules 702, it may be desirable to utilize and assign multiple ones of the context-identifier modules 702 to the particular one of the plurality of contexts 104, with each context-identifier module in the context-identifier modules 702 assigned to the particular one of the plurality of contexts 104 performing one of the multiple context-identifier algorithms. Assigning multiple ones of the context-identifier modules 702 to the single one of the plurality of contexts 104 could also be beneficial for purposes of software testing.

In other embodiments, it may be advantageous to assign one context-identifier module in the context-identifier modules 702 to multiple ones of the plurality of contexts 104. For example, if the plurality of contexts 104 is organized into the hierarchy discussed above, there may be a sports context that is a superset of baseball, football, hockey, and tennis contexts. In this situation, it may be advantageous to additionally assign various context-identifier modules in the context-identifier modules 702 that are assigned to the baseball, football, hockey, and tennis contexts to the sports context. In some embodiments, one benefit of this arrangement is that, if there are cohesive segments 418 that are identified by, for example, the hockey context identifier but not the sports context identifier, the cohesive segments 418 identified with the hockey context will still be identified with the sports context.

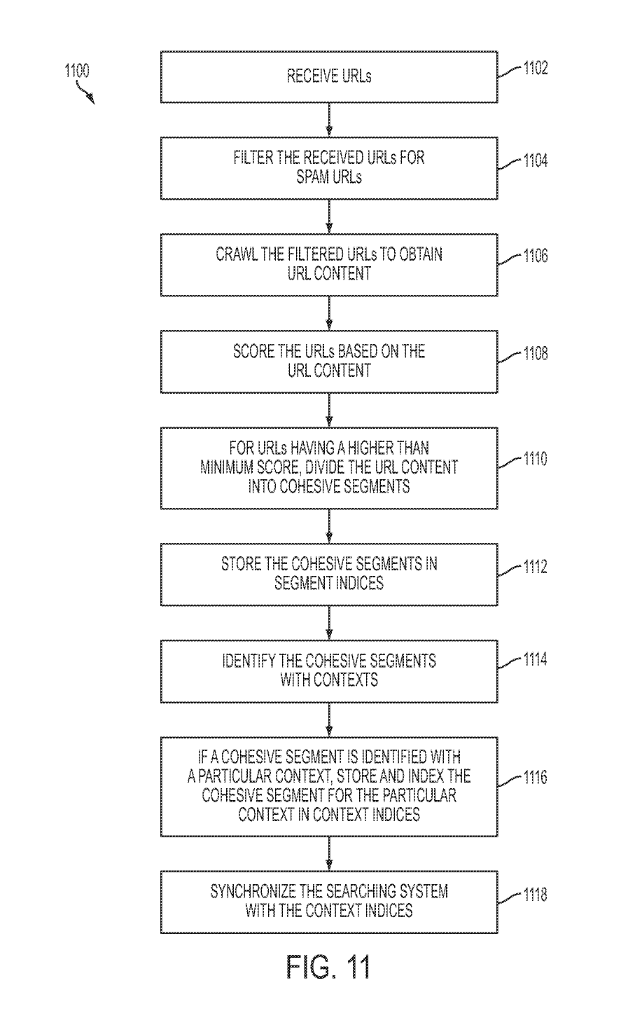

FIG. 11 illustrates a process 1100 for utilizing a system for context-based searching such as, for example, the search engine system 300 described with respect to FIG. 3. At step 1102, URLs are received. As described with respect to FIG. 4, the URLs may be provided, for example, from the Internet cloud 312, the third-party domain list 426, or the custom-defined domain list 428. From step 1102, the process 1100 proceeds to step 1104. At step 1104, the received URLs are filtered for spam URLs that should not be indexed. The received URLs may be filtered by, for example, the domain filter 402 as described with respect to FIGS. 4 and 5. From step 1104, the process 1100 proceeds to step 1106. At step 1106, the filtered URLs are crawled to obtain Internet content corresponding to the filtered URLs by, for example, the web crawler 406 as described with respect to FIG. 4.

Still referring to FIG. 11, from step 1106, the process 1100 proceeds to step 1108. At step 1108, the filtered URLs are scored based on the URL content by, for example, the domain scorer 410 as described with respect to FIG. 4. From step 1108, the process 1100 proceeds to step 1110. At step 1110, URLs meeting a minimum quality standard as determined by a minimum score are divided into cohesive segments, for example, in the manner described with respect to FIGS. 4 and 6. From step 1110, the process 1100 proceeds to step 1112. At step 1112, the cohesive segments are stored in segment indices such as, for example, the segment indices 416 as described with respect to FIG. 4.

Still referring to FIG. 11, from step 1112, the process 1100 proceeds to step 1114. At step 1114, cohesive segments are identified with contexts, for example, as described with respect to FIGS. 7-10. From step 1114, the process 1100 proceeds to step 1116. At step 1116, if a cohesive segment is identified with a particular context, the cohesive segment is stored and indexed in context indices for the particular context such as, for example, context indices 424 as described with respect to FIGS. 4 and 7. From step 1116, the process 1100 proceeds to step 1118. At step 1118, a searching system such as, for example, the searching system 306, is synchronized with the context indices in order to allow context-based searching.

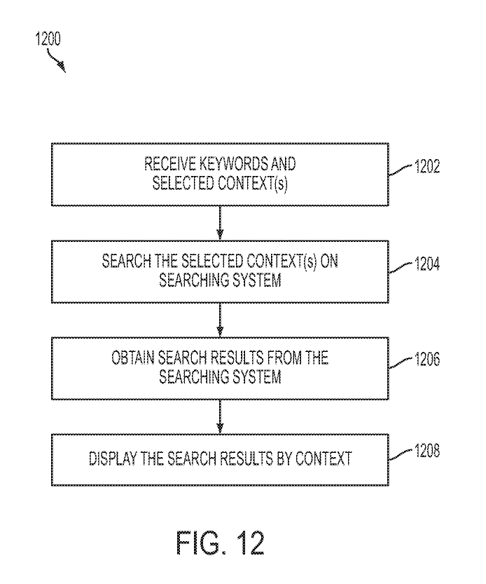

FIG. 12 illustrates a process 1200 for performing context-based searching in accordance with principles of the invention. At step 1202, a search request and selected contexts for searching with the search request are received from an Internet user. For example, the search request may be the search request 102 described with respect to FIG. 1 and the selected contexts may be selected ones of the plurality of contexts 104. By way of further example, the search request may be received through the search interface 100 as described with respect to FIG. 1.

Still referring to FIG. 12, from step 1202, the process 1200 proceeds to step 1204. At step 1204, the selected contexts are searched using the search request, for example, via the searching system 306 described with respect to FIG. 3. From step 1204, the process 1200 proceeds to step 1206. At step 1206, search results for each of the selected contexts are obtained from the searching system. From step 1206, the process 1200 proceeds to step 1208. At step 1208, the search results are transmitted and displayed by context to the Internet user such as, for example, in the manner described with respect to the exemplary search results 200 in FIG. 2.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A context-based searching method comprising:
retrieving content over a computer network;
segmenting the content into a plurality of cohesive segments;
identifying at least one cohesive segment of the plurality of cohesive segments with at least one context of a plurality of contexts resident on one more computer-readable storage media in a searching system; and
indexing, in the plurality of contexts, the at least one cohesive segment identified with the at least one context.

2. The method of claim 1, comprising:
receiving a search request and a selection of at least one context of the plurality of contexts from a user; and
searching only the at least one context selected by the user.

3. The method of claim 2, comprising:
responsive to the searching step, retrieving cohesive segments from the at least one context selected by the user; and
over the computer network, providing the retrieved cohesive segments by context to the user.

4. The method of claim 1, comprising:
receiving a list of Uniform Resource Locators (URLs); and
wherein the content is retrieved by accessing URLs in the list of URLs.

5. The method of claim 4, comprising:
filtering the list of URLs for spam URLs; and
wherein the content is retrieved by accessing URLs in the filtered list of URLs.

6. The method of claim 4, comprising scoring the URLs in the list of URLs based on the content retrieved by accessing the URLs in the list of URLs.

7. The method of claim 1, wherein the identifying step comprises utilizing a series of context-identifier modules, each context-identifier module in the series of context-identifier modules implementing a context-identifier algorithm, each context-identifier module in the series of context-identifier modules being assigned to at least one context of the plurality of contexts.

8. The method of claim 1, wherein the identifying step comprises identifying the at least one cohesive segment of the plurality of cohesive segments with more than one of the plurality of contexts.

9. A context-based searching system comprising:
a searching system comprising:
at least one searching machine; and
a plurality of contexts resident on one or more computer-readable storage media on or accessible to the at least one searching machine;
a content procurement and organization system comprising:
a web crawling system comprising a web crawler that retrieves content over a computer network; and
a context identifier operable to:
segment the content into a plurality of cohesive segments; and
identify at least one cohesive segment of the plurality of cohesive segments with at least one context of the plurality of contexts;
a context indexer operable to index, in the plurality contexts, the at least one cohesive segment identified with the at least one context.

10. The context-based searching system of claim 9, wherein the searching system is operable to:
receive a search request and a selection of at least one context of the plurality of contexts from a user; and
search only the at least one context selected by the user.

11. The context-based searching system of claim 10, wherein the searching system is operable to:
responsive to the searching step, retrieve cohesive segments from the at least one context selected by the user; and
over the computer network, provide the retrieved cohesive segments by context to the user.

12. The context-based searching system of claim 9, wherein:
the web crawler is operable to receive a list of Uniform Resource Locators (URLs); and
the content is retrieved by accessing URLs in the list of URLs.

13. The context-based searching system of claim 12, wherein:
the web crawling system comprises a domain filter operable to filter the list of URLs for spam URLs; and
the content is retrieved by accessing URLs in the filtered list of URLs.

14. The context-based searching system of claim 12, wherein the web crawling system comprises a domain scorer operable to score the URLs based on the content retrieved by accessing the URLs in the list of URLs.

15. The context-based searching system of claim 9, wherein the context identifier comprises:
a series of context-identifier modules, each context-identifier module of the series of context-identifier modules implementing a context-identifier algorithm;
wherein each context-identifier module of the series of context-identifier modules is assigned to at least one context of the plurality of contexts; and
wherein the identification of the at least one cohesive segment of the plurality of cohesive segments with the at least one context of the plurality of contexts comprises utilization of the series of context-identifier modules.

16. The context-based searching system of claim 9, wherein the at least one cohesive segment of the plurality of cohesive segments is identified with more than one of the plurality of contexts.

17. An article of manufacture for context-based searching, the article of manufacture comprising:
at least one computer readable medium;
processor instructions contained on the at least one computer readable medium, the processor instructions configured to be readable from the at least one computer readable medium by at least one processor and thereby cause the at least one processor to operate as to perform the following steps:
retrieving content over a computer network;
segmenting the content into a plurality of cohesive segments;
identifying at least one cohesive segment of the plurality of cohesive segments with at least one context of a plurality of contexts resident on one more computer-readable storage media in a searching system; and
in the plurality of contexts, indexing the at least one cohesive segment identified with the at least one context.

18. The article of manufacture of claim 17, wherein the processor instructions are configured to cause the at least one processor to operate as to perform the following steps:
receiving a search request and a selection of at least one context of the plurality of contexts from a user; and
searching only the at least one context selected by the user.

19. The article of manufacture of claim 18, wherein the processor instructions are configured to cause the at least one processor to operate as to perform the following steps:
responsive to the searching step, retrieving cohesive segments from the at least one context selected by the user; and
over the computer network, providing the retrieved cohesive segments by context to the user.

20. The article of manufacture of claim 17, wherein:
the processor instructions are configured to cause the at least one processor to operate as to perform the following step:
receiving a list of Uniform Resource Locators (URLs); and
the content is retrieved by accessing URLs in the list of URLs.

21. The article of manufacture of claim 20, wherein:
the processor instructions are configured to cause the at least one processor to operate as to perform the following step:
filtering the list of URLs for spam URLs; and
the content is retrieved by accessing URLs in the filtered list of URLs.

22. The article of manufacture of claim 20, wherein the processor instructions are configured to cause the at least one processor to operate as to perform the following step:
scoring the URLs based on the content retrieved by accessing the URLs in the list of URLs.

23. The article of manufacture of claim 17, wherein the identifying step comprises utilizing a series of context-identifier modules, each context-identifier module in the series of context-identifier modules implementing a context-identifier algorithm, each context-identifier module in the series of context-identifier modules being assigned to at least one context of the plurality of contexts.

24. The article of manufacture of claim 17, wherein the identifying step comprises identifying the at least one cohesive segment of the plurality of cohesive segments with more than one of the plurality of contexts.

25. A context-based searching method comprising:
receiving a search request and a selection of at least one context of a plurality of contexts from a user, the plurality of contexts being resident on at least one computer-readable medium in a searching system, the plurality of contexts each containing a plurality of cohesive segments of content identified with the context;
searching only the at least one user-selected context of the plurality of contexts;
responsive to the searching step, retrieving cohesive segments from the at least one user-selected context; and
over the computer network, providing the retrieved cohesive segments by context to the user.
